(19) United States
(12) Patent Application Publication
(10) Pub. No.: US 2017/0140131 A1
(43) Pub. Date: May 18, 2017

(54) Distributed Hardware Security System

(71) Applicant: Hiperwall, Inc., Irvine, CA (US)

(72) Inventors: Jeff Greenberg, Irvine, CA (US); Stephen F. Jenks, Irvine, CA (US); Sung-Jin Kim, Irvine, CA (US)

(21) Appl. No.: 14/940,786

(22) Filed: Nov. 13, 2015

(51) Int. Cl. G06F 21/10; H04L 29/06

(52) U.S. Cl. CPC G06F 21/105; H04L 63/12

(57) ABSTRACT

A distributed hardware security system can include one or more anti-pirating/license verification devices, such a dongle (or other internal or external devices) that can be used prevent piracy of protected property such as devices, features, software, or selected functionalities thereof while reducing the potential for unintended termination or suspension of access to the licensed property. In some embodiments, a multi-processor system can include a distributed hardware security system having multiple computing devices, such as display nodes, PCs, workstations, or other devices. The security system can include functionality for detecting a plurality of authorized license verification devices on the same system, and for determining if continued access to the licensed property can continue if there is a failure to recognize one or more of the authorized license verification devices.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

Field of the Invention

The inventions disclosed herein generally related to license control, for example, licensing control for software and/or hardware.

Description of the Related Art

Some known electronic systems, which can include a combination of software and hardware, are subject to limited-use licenses. For example, some such systems require attachment of one encoded piece of hardware, known as a “dongle”, for all of part of the system to function. A seller issues one dongle for each licensed purchased. The purchaser can then operate a number of systems in parallel, provided each system includes one attached dongle. As such, the seller of such a system can ensure that a purchaser can only operate the specific number of systems purchased.

### SUMMARY OF THE INVENTION

An aspect of at least one of the inventions disclosed herein includes the realization that availability of multi-processor systems subject to limited-use, license verification devices, such as dongles, can be improved with the incorporation of a distributed hardware security system with one or more license verification devices.

Unintended loss of access to a licensed property can be unsatisfactory for some users, even if such loss is temporary. Some protected properties, such as software, require a single, unique licensed dongle to be connected to the computer in order for the software to function at all or for access to specific licensed modules providing specific functionalities. If the single dongle is damaged access to the licensed property would be suspended until the user is provided with a replacement dongle, which would be subject to the time required for physical delivery or other delivery delays. Additionally, property owners can choose to decline to issue more than one dongle for each purchased license, to prevent unauthorized use of the property.

One type of system that can be considered to be a multi-processor system is a display system which includes an array of individual displays units cooperating as a display system. For example, some such display systems can include a plurality of devices with sufficient processing functionality to cooperate as a distributed hardware security system, e.g., a system in which different required security-related functionalities are performed by different modules which may be included in different devices, which may in different physical locations.

Thus, in some embodiments, a multi-processor system including a plurality of different devices, each including a processor, and includes a distributed hardware security system. The distributed hardware security system can include a plurality of license verification devices connected to different devices of the system. The distributed hardware security system can detect the plurality different license verification devices connected to the system and allow continued access to the licensed property operation if less than all of the license verification devices are connected to the system.

In accordance with some embodiments, a computerized display system includes a plurality of displays, wherein each display of the plurality of displays is deployed in close proximity to another display in the plurality of displays, a plurality of display nodes comprising computer hardware, each display node configured to display content on at least one locally connected display of the plurality of displays, each display node connected via local area network to an authorization node, wherein n display nodes in the plurality of display nodes are each electronically connected to, and associated with, a separate, unique license dongle of n dongles, wherein each individual display node in the n display nodes are configured to periodically detect the status of the unique license dongle associated with the individual display node, periodically transmit the status of the unique license dongle to the authorization node based on the detected status, The system also includes the authorization node, the authorization node configured to, based on received statuses of dongles from the n display nodes, detect whether m of n license dongles are valid, wherein m is greater than 1, and in response to detecting less than m license dongles as valid, terminate display capabilities of the computerized display system.

According to various embodiments, disclosed herein is a computerized method of authorizing an arrayed display system including n discrete display devices disposed adjacent one another, the method comprising periodically receiving, over a local area network, an active dongle status indication from one or more of the n discrete display devices, wherein each of the n discrete display devices are electronically connected to an external license dongle and n is greater than 1, verifying an authorized license for each active dongle status indication received, determining whether less than m dongles are authorized based on verification of each authorized license, wherein m is greater than 1, and in response to determining that less than m dongles are authorized, terminating display capabilities of at least a portion of the arrayed display system.

According to other embodiments, a computer program is disclosed that is stored in a computer readable media and configured to cause a computer to control the display of media objects on an arrayed display system including a plurality of display devices disposed adjacent one another, the program comprising a display media control module configured to determine the media to display on at least one of the plurality of display devices, and a license authorization module configured to determine whether m dongles are authorized out of n total, unique dongles distributed among, and electronically connected to, individual display devices of the plurality of display devices, the license authorization module further configured to terminate the display capabilities of one or more of the plurality of display devices in response to determining that less than m authorized dongles are functioning throughout the plurality of display devices.

In some embodiments, them may be greater than half of n. For example, m is equal to 2 and n is equal to 3. In other embodiments, m may be equal to 3 and n is equal to 5.

In various embodiments, the authorization node is a control node, the control node may be further configured to assign display information to each display node of the plurality of display nodes.

In some implementations, a second redundant authorization node distinct from the authorization node may be configured to, based on received statuses of dongles from the n display nodes, detect whether m of n license dongles are valid, and in response to detecting less than m license dongles as valid, terminate display capabilities of the computerized display system.

In accordance with some embodiments, the second redundant authorization node is further configured to only terminate display capabilities of the computerized display system if, additionally, the authorization node is unresponsive.

In some configurations, the second redundant authorization node is an assignable role among the plurality of display nodes. In some embodiments, the display system may verify, via the Internet, with a license server, the authorization status of each unique license dongle.

According to various embodiments, the license authorization module may be further configured to transmit a keep-alive indication to a backup license authorization module.

In yet another embodiment, a computer program stored in a computer readable media can be configured to provide functionality amongst a plurality of processor devices and distributed-hardware security. The program can comprise a license authorization module configured to recognize n licensed security devices connected to a plurality of different processor devices connected by a network. The license authorization module can be configured to determine whether at least m licensed security devices are attached to m of the different processor devices connected to the network. The license authorization module further configured to terminate at least one capability of one or more of the plurality of processor devices in response to determining that less than m authorized dongles are functioning throughout the plurality of display devices, wherein m is less than n.

For purposes of summarizing the disclosure, some aspects, advantages and novel features of the inventions are disclosed herein. Not necessarily all such advantages can be achieved in accordance with any particular embodiment of one or more of the inventions disclosed herein. Thus, the inventions disclosed herein can be embodied or carried out in a manner that achieves or optimizes all of the advantages, or only one advantage or group of advantages as taught herein without necessarily achieving other advantages disclosed or suggested herein.

### BRIEF DESCRIPTION OF THE DRAWINGS

The above-mentioned and other features of the inventions disclosed herein are described below with reference to the drawings of preferred embodiments. The illustrated embodiments are intended to illustrate, but not to limit the inventions. The drawings contain the following Figures:

FIG. 1 is a schematic diagram illustrating an embodiment of a system for dynamic management of data streams of image data to a display array with a distributed hardware security system.

FIG. 2 is a schematic diagram illustrating another embodiment of system for dynamic management of data streams of image data to a display array with a distributed hardware security system.

FIG. 3 is a flow chart of an embodiment of a method that can be used for operation of any of the distributed hardware security systems of FIGS. 1 and 2.

FIG. 4 is a flow chart of another embodiment of a method that can be used for operation of any of the distributed hardware security systems of FIGS. 1 and 2.

### DETAILED DESCRIPTION OF THE PREFERRED EMBODIMENT

The present disclosure generally relates distributed hardware security systems which can be used to prevent unauthorized use of devices, systems, processes, software stored in computer-readable media, as well as other apparatuses and methods. The embodiments disclosed herein are described primarily in the context of systems including a plurality of communication devices, such as input-output devices, disposed at different physical locations. These embodiments are described in the context of display systems including array-type displays for displaying any type of visual information, because they have some particular benefits in these contexts. However, the inventions disclosed herein can be used in other types of systems as well.

The term “image,” as used herein, in addition to having its ordinary meaning, refers to a graphical or visual representation of any kind of media, including both still and active graphical or visual content or data, such as still image data, streaming data, video data (e.g., movies), content received using screen sender technology, applications windows (e.g., spreadsheet and word processing applications, etc.) and/or the like. In some embodiments, a system that implements a highly interactive large image or parallel display system can be used.

The term “dongle,” as used herein is intended to refer to a small piece of hardware that attaches to a computer, TV, or other electronic device in order to enable additional functions such as copy protection, audio, video, games, data, or other services. These services would be available only when the “dongle” is attached. The term “attached,” as used herein, does not need to involve a wired connection. The dongle can communicate wirelessly with the device it enables via NFC, for example.

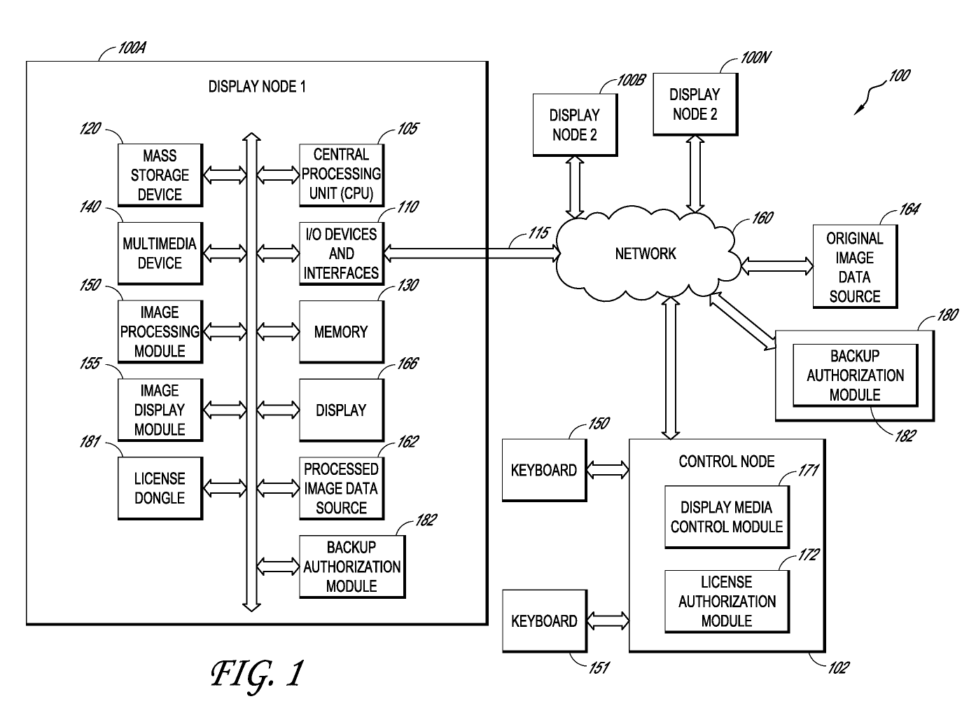

FIG. 1 is a block diagram showing of a plurality of display nodes 100A (including display nodes 100A, 100B, and 100N that are representative of any quantity of display nodes) that are in communication with a network 160 and other devices via the network 160, including an optional control node 102, which can also be referred to as a “primary workstation” in some embodiments. Each of the nodes 100N can include a display area (display 166) and integrated control hardware and/or software. Visual data, such as video image data discussed below, can be stored in any device connected to the network, including the nodes 100N, the control node 102, or any other device. In some embodiments, original image data source 164 can be a mass storage device or computing system, also in communication with the network 160. In some embodiments, the tiled display system 100 comprises a single discrete display device (e.g., a projector or a standalone large display). In other embodiments, the tiled display system 100 comprises an array of discrete display devices or multiple arrayed display walls. In some embodiments, the tiled display system 100 comprises multiple arrayed display walls and one or more standalone display devices (e.g., “satellite” monitors).

Generally, the control node 102 can comprise one or more computing devices that gather or make available information about the state of the overall tiled display system 100, including display nodes 100, through the use of messages. For example, the control node 102 can include a desktop, laptop, tablet, netbook, handheld computing device (e.g., a smartphone or PDA), a server, or the like. In addition, the control node 102 can function as a front end interface to the tiled display system 100 that allows a user to interact with the overall system 100 by manipulating the parallel display, for example.

Any of the display nodes 100N and control node 102 can be used to implement certain systems and methods described herein, including all of the embodiments and optional features of the distributed hardware security system described herein. For example, in some embodiments, the display node 100A and control node 102 can be configured to be attachable to licensed dongle 181, can manage the display of information on tiled display systems, as well as other functionalities and/or hardware. The functionality provided for in the components and modules of the display node 100A and control node 102 can be combined into fewer components and modules or further separated into additional components and modules. The licensed dongle 181 can be issued for use on a system 100 of a specific configuration, such as system 100 which includes the display nodes 100N, control node 102 and the original data source 164. As such, system 100 can be considered to be a “licensed system”.

In some embodiments, the display node 100A can include, for example, a computing device, such as a personal computer that is IBM, Macintosh, or Linux/Unix compatible. In some embodiments, the computing device comprises a server, a laptop computer, a cell phone, a personal digital assistant, a kiosk, or an audio player, for example.

With continued reference to FIG. 1, although only exemplary components of the display node 100A are described in detail, it is to be understood that the descriptions of the display node 100A set forth herein also apply to the other nodes 100B, 100N.

In some embodiments, the display node 100A can include a central processing unit (“CPU”) 105, which can include one or more microprocessors, graphics processors, digital signal processors, or the like. The display node 100A can further include a memory 130, such as random access memory (“RAM”) for temporary storage of information and a read only memory (“ROM”) for permanent storage of information, and a mass storage device 120, such as one or more hard drive, diskette, and/or optical media storage device. Typically, the modules of the display node 100A are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The display node 100A can be controlled and coordinated by operating system software, such as Windows 95, Windows 98, Windows NT, Windows 2000, Windows XP, Windows Vista, Linux, SunOS, Solaris, a real-time operating system (RTOS), or other compatible operating systems. In Macintosh systems, the operating system can be any available operating system, such as MAC OS X. In other embodiments, the display node 100A can be controlled by a proprietary operating system. The operating systems can control and schedule computer processes for execution, perform memory management, provide file system, networking, and I/O services, and provide a user interface, such as a graphical user interface (“GUI”), among other things.

The exemplary display node 100A can include one or more commonly available input/output (I/O) devices and interfaces 110, such as a keyboard, mouse, touchpad, touch screen device, and printer. In addition, display node 100A can include one or more display devices 166, such as a monitor, that allows the visual presentation of data, such as the image data described herein, to a user. More particularly, a display device provides for the presentation of scientific data, GUIs, application software data, and multimedia presentations, for example. The display node 100A can also include one or more multimedia devices 140, such as speakers, video cards, graphics accelerators, and microphones, for example.

In some embodiments, the I/O devices and interfaces 110 can provide a communication interface to various external devices. The display node 100A can be coupled to a network 160 that comprises one or more of a LAN, WAN, or the Internet, for example, via a wired, wireless, or combination of wired and wireless, communication link 115. The network 160 communicates with various computing devices and/or other electronic devices via wired or wireless communication links including for example but without limitation, 802.11 protocols, short range protocols such as Bluetooth, near field communication protocols, or other protocols.

In the embodiment of FIG. 1, display node 100A can include, or can be coupled to via a network connection, to a processed image data source 162, such as a database, that includes information about one or more images or other media to display.

In addition to the devices that are illustrated in FIG. 1, display node 100A can be connected to original image data source 164 or computing devices through a bus or network 160.

Images stored in original image data source 164 can be compressed or uncompressed images. In some embodiments, the processed image data source 162 can also be configured to receive a compressed image from the original image data source 164. Once received, display node 100A can decompress an original image and then preprocess the original image into a set of one or more images that are compressed or decompressed and store them in the processed image data source 162. Spatial identifiers can be used to identify various portions of the images to facilitate extraction of different regions of the original image.

In some embodiments, one or more of the data sources can be implemented using a relational database, such as Sybase, Oracle, CodeBase and Microsoft® SQL Server as well as other types of databases such as, for example, a flat file database, an entity-relationship database, an object-oriented database, and/or a record-based database.

With continued reference to FIG. 1, in some embodiments the display node 100A can also include application modules that can be executed by the CPU 105. In some embodiments, the application modules include the image processing module 150 and image display module 155. These modules can include, by way of example, hardware and/or software components, such as software components, object-oriented software components, class components and task components, processes, functions, attributes, procedures, subroutines, segments of program code, drivers, firmware, microcode, circuitry, data, databases, data structures, tables, arrays, and variables. Examples of such optional functionalities and configurations are further described in U.S. patent application Ser. No. 14/304,322, filed Jun. 13, 2014, the entire contents of which is hereby expressly incorporated by reference.

In some of the embodiments described herein, each display node 100A can be configured to execute instructions in the image processing module 150, among others, in order to support user interactivity by reducing the amount of data loaded into memory when an image is to be displayed on the tiled display system. For example, the control node 102 can include a display media control module 171 for providing the display-related functionalities of the control node 102 described herein. Additionally, as described in greater detail below, the control node 102 can also include a license authorization module 172 which can include any embodiments of the distributed hardware security system disclosed herein.

Although FIG. 1 has been described with respect to display nodes 100, a control node 102, and an image data source 164, certain of the features of the system shown in FIG. 1 can be implemented using other types of computing devices communicating over the network 160.

The control node 102 can broker a connection between the media source device and a destination computing device. In some embodiments, the control node 102 can be configured to locate media data stored on the media source device 164 and obtains the media data or a portion thereof (such as a thumbnail) from the media source device. The control node 102 can then send the media data or the portion thereof to the destination computing device, along with network communication or connectivity data. The network communication data can enable the destination computing device to communicate with the media source device to obtain media data. The network communication data could include, for example, a network address (such as an IP address) of the media source device, a proxy for the media source device, an anycast IP address for a plurality of media source devices, or the like.

Advantageously, in certain embodiments, providing the network communication data from the control node 102 to the destination computing device enables the destination computing device to obtain media, including media updates, from the media source device. As a result, the control node 102 can be less of a bottleneck for communications between the media source device and the destination computing device.

In some embodiments, the destination computing device can report or otherwise provide the media updates it receives or a portion thereof to the control node 102. For example, the destination computing device can provide a thumbnail, a reduced frame rate video, metadata associated with the media updates, combinations of the same, and the like. The control node 102 can therefore keep track of the media data provided to the destination control device.

In some embodiments, license authorization module 172 can be included in the control node 102, in any of the display nodes 100N, or in another location. Regardless of its location in the system 100, the license authorization module 172 can form part of the distributed hardware security systems disclosed herein. In some embodiments, the distributed hardware security system can be considered as including the license authorization module 172, and at least one licensed dongle 181 attached directly to the control node 102 containing the license authorization module 172. In some embodiments, the distributed hardware security system can be configured to recognize the licensed dongle 181 when it is attached to a part of the system 100 at a location remote from the license authorization module 172, e.g., not directly connected to the device containing the license authorization module 172. For example, in embodiments of FIG. 1, the license authorization module 172 can be configured to recognize a licensed dongle 181 attached directly to the control node 102 and/or in any display node 100N. As such, the licensed dongle 181 can be attached to any part of the licensed system 100.

With continued reference to FIG. 1, each display node 100N and/or the control node 102 can be attached to a licensed dongle 181. In some embodiments, the licensed dongle is in the form of a memory device with a USB port and/or a wireless transceiver for near field communication, Bluetooth, 802.11, or other wireless communication protocols. Further, the licensed dongle 181 can comprise any optional hardware and/or software configurations configured to provide a security response that can be used to confirm, for example, that a computer is connected to the licensed dongle 181. The license authorization module 172 can be configured allow or prevent use of a licensed feature depending on the confirmation.

The licensed dongle 181 can be an electronic copy protection and content protection device which when attached to a computer or other electronic device unlocks software functionality and/or decodes content. In some embodiments, a hardware key stored on the licensed dongle 181 is programmed with a product key or other cryptographic protection mechanism. The licensed dongle 181 attaches to a computing device by way of an electrical connector to an external bus (USB) of a computing device, with wireless communications, or other manners for attachment.

In some embodiments, the licensed dongle 181 can include two interface security tokens with transient dataflow so that it does not interfere with other dongle functions and a poll communication that reads security data from the dongle. Software running in the control module 102 or any of the display nodes 100N, used for operating the display system 100, can be configured such that, without a confirmed attachment of the licensed dongle 181 from the license authorization module 172, the software may run only in a restricted mode or not at all.

For example, in some embodiments, a display node 100N can be prevented, by the license authorization module 172, from displaying information or providing functionality that it would otherwise display or provide, if the license authorization module 172 does not confirm that the required one or more licensed dongles 181 are attached. In some cases, a licensed dongle 181 is only needed for the permanent operation of a feature whereas without a licensed dongle 181 or if the licensed dongle 181 is malfunctioning, a feature can be allowed to temporarily be used but shut off at a point sometime in the future.

In some embodiments, a licensed dongle 181 can be attached to a USB interface or a serial or a parallel port interface or could be attached to an Apple lightning connector, or other mobile device connector or a fire wire connector or any wired or wireless communication port on a computer. Some embodiments of the licensed dongle 181 are configured to function in response to a presence checking function, for example, the licensed dongle 181 would return a positive response to the checking function if it were attached and were an authorized, licensed dongle 181. Some embodiments of the licensed dongle 181 can be configured with encryption mechanisms designed to thwart reverse engineering. For example, some embodiments of the licensed dongle 181 contain a memory that can be used to store and execute software directly from the dongle itself. In some embodiments, the licensed dongle 181 can include a processor for executing software on the licensed dongle 181. Thus, in some sense, a licensed dongle 181 can be considered a processor in and of itself that can execute program instructions stored on the licensed dongle 181 in clear or encrypted forms.

In some embodiments, a licensed dongle 181 can include a known passive RFID circuit configured to issue a response when exposed to a signal. In other embodiments, the licensed dongle 181 can be configured to require external information, in order for a program, or in this example, a set of software, running on all the display nodes 100N to function correctly.

In some embodiments, a licensed dongle 181 is designed with a code porting process which can transfer encrypted parts of the software to be executed into a secure hardware environment such as a smart card, to run. In other cases, a computer program can port thousands of lines of code to be executed on the licensed dongle 181 that can have special processing features. Any other type of dongle can also be used.

In the system 100, one or more of the display capabilities of all or one of the display nodes 100N, functionalities of the control node 102, or any other feature of the system 100, can be a “licensed feature”. Absent a conforming attachment of one or more licensed dongles 181 correctly functioning, the system 100 would not display or perform the licensed feature.

In some embodiments, a plurality of display nodes 100N in a display system, 100 can have such a licensed dongle 181. In some embodiments of the distributed hardware security system disclosed herein, at least two licensed dongles 181 must be attached to the system 100 for use of the licensed feature.

In further embodiments, the distributed hardware security system can be configured to allow use of a licensed feature if a number less than all of the licensed dongles 181 are attached to the system 100. Additionally, the distributed hardware security system can be configured to require a number of attached licensed dongles 181, that is less than the total number of licensed dongles 181, but is sufficient to prevent un-attached licensed dongles 181 from being used for operation of another, unlicensed system.

For example, distributed hardware security system can be configured to recognize 3 or more licensed dongles 181 attached to the system 100 for use of a licensed feature and also be configured to allow use of a licensed feature if at least two or more of the three licensed dongles 181 are attached to the system 100. Further, the distributed hardware security system can be configured to recognize more than three attached licensed dongles 181. In such embodiments, the distributed hardware security system can be configured to allow use of the licensed feature if a simple majority of the licensed dongles 181 are attached. This can provide desirable benefits.

For example, licensed dongles 181 can fail and can be damaged or lost. If a system requires all licensed dongles to be attached all the time, the failure or absence of one dongle can prevent authorized use of a system 100, which an authorized user may find inconvenient or frustrating.

Thus, by configuring the distributed hardware security system to recognize a plurality of licensed dongles 181, users can avoid interruptions of proper, authorized use of licensed features. Additional benefits can be achieved by configuring the distributed hardware security system to recognize a plurality of licensed dongles 181 and allow use of a licensed feature only if at least a majority of the licensed dongles 181 are attached. As such, a user could not use any remaining unattached licensed dongles 181, for example, operate an unlicensed copy of the licensed feature because the unattached licensed dongles 181 would be fewer in number than a majority of all of the licensed dongles 181. As such, the distributed hardware security system can be configured recognize a plurality of licensed dongles 181, all of which are configured to provide a correct authentication or response, then, based on a determination by the license authorization module 172, the display on each display node can continue to function even though less than all of the licensed dongles 181 are attached.

For example, the control mode 102, or any other part of the system 100, can include a licensed authorization module 172 which can be configured to perform a process of determining whether or not to allow use of the licensed feature on any or all of the display nodes 100N based on the determination if the required number of licensed dongles 181 are attached, which can include indications from all of the display nodes 100N in the display array that are on local area network 160. In some embodiments, the distributed hardware security system can be configured determine that a subset of all of the display nodes 100N, for example, one display node such as display node 100B, does not have a working, licensed dongle 181, then the entire display array, including display node 100B can continue functioning. This helps alleviate critical mission applications from failing due to a single dongle failure.

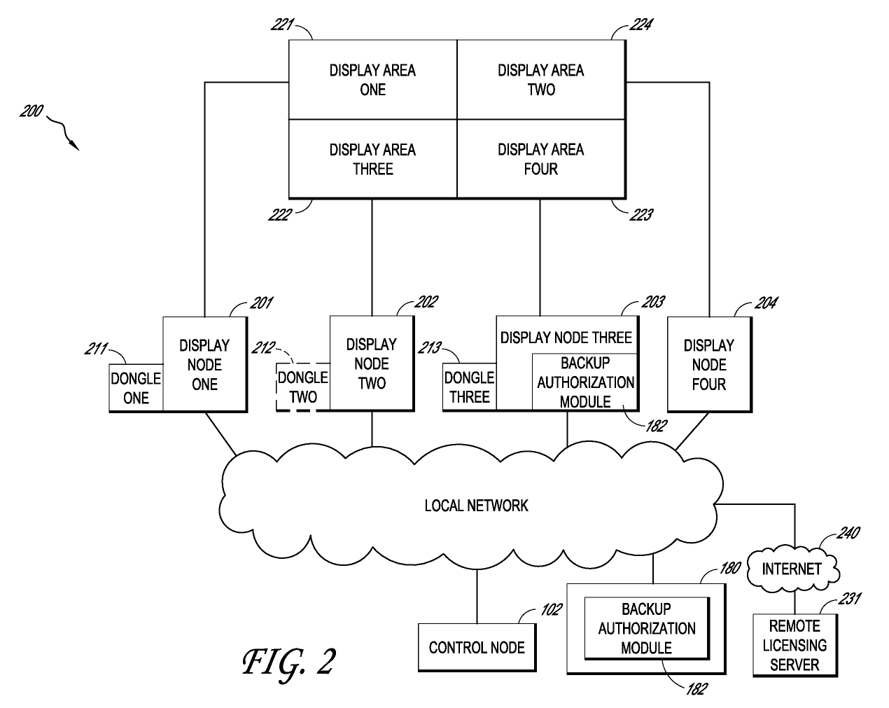

FIG. 2, illustrates another embodiment of the system 100, identified generally with the reference numeral 200. The above descriptions of the parts, components, features and functionality of the system 100 also apply to the corresponding parts of the system 200, except where expressly noted below.

The system 200 can include a remote licensing server 231 and a display array, in the illustrated embodiment, comprising four or more visual areas: display area one 221, display area two 222, display area three 223, and display area four 224. Display area one 221 is controlled by display node one 201. Display area two 222 is controlled by display node two 202. Display area three is controlled by display node three 203. And display area four 224 is controlled by display node four 204.

As illustrated in FIG. 2, display node one 201 is attached to licensed dongle one 211. Display node two 202 is attached to licensed dongle two 212, display node three 203 is attached to licensed dongle three 213, and display node four does not have a dongle although in some embodiments it could be attached to one.

Each of these display nodes 201, 202, 203, and 204 are connected to a local area network such as LAN 220 and can be controlled as to where and/or how to display content from control node 102. The local area network and therefore the display nodes 201, 202, 203, and 204 and control 102 node can connect to the internet 240 which can allow them to contact remote licensing server 231 that is also connected to the internet. For example, the remote licensing server 231 can be operated by a third party, such as the licensor of the licensed feature in order to confirm conforming attachment of authorized licensed dongles that are attached to any part of the system 200.

For example, each display node that has a dongle, such as display node three 203 having dongle three 213, can be configured to contact the remote licensing server 231 in order to confirm conforming attachment of dongle three 213. Such a message can be an encrypted message generated by the dongle three 213 and can contain an ID or identification of the dongle three 213 so that the remote licensing server 231 can verify that dongle three 213 is an authorized dongle.

The remote licensing server 231 can be configured to confirm that dongle three 231 is an authorized dongle and then send a message back to the display node 203 or to the control node 102 including data corresponding to an indication that dongle three 213 is a valid dongle. On the other hand, the remote licensing server 231 can send a message to the control node 102 or to the display node 203 that dongle three 231 is not a valid dongle and therefore should not be considered a working or valid dongle when determining if there is a conforming attachment of licensed dongles and thus whether use of the licensed feature on system 200 is authorized.

In the embodiments described above with reference to FIG. 2, only display node one 201, display node two 202, and display node three 203 are attached to dongles. Display node four 204 is not attached to a dongle. However, display node four 204 can be considered part of a licensed system and allowed to provide a licensed feature. In such embodiments, use of the licensed feature on display node four 204 depends on the confirmation of conforming attachment of dongles one, two, and three 211, 212, 213.

Thus, in such embodiment, the dongles 211, 212, 213 that are attached to display node one 201, display node two 202, and display node three 203, affect all of the display nodes in the display array and the absence or failure of only one of the dongles 211, 212, 213, would not prevent use of the licensed feature. Instead, in such embodiments, confirmation of the attachment of M of N authorized, functioning dongles in the display system 200 will enable all of the display nodes 201, 202, 203, 204 and/or the control node 102 to function.

For example, in FIG. 2, dongle two 212 is illustrated in phantom line to represent that dongle two 212 is attached but not functioning. Therefore, when display node two 202 queries or interacts with in any way dongle two 212, an error or lack of an authorized response will result. For example, depending on the configuration, it could be determined that dongle two 212 contains an ID that is not considered authorized, as determined by the remote licensing server 231 or display node two 202, or no response or a corrupted response is issued from dongle two 202 when queried. Thus, it can be determined that system 200 is not attached to dongle two 212.

In some embodiments, the determination of the failure of a conforming attachment with dongle two 212 can be used to prevent display node two 202 from providing the licensed feature.

Additionally, during operation of some known systems using a single dongle, absence or damage to the single dongle prevents the entire system from authorized operation.

In contrast, in some of the embodiments of FIGS. 1 and 2, the absence or failure of a single dongle does not prevent any use of the licensed feature, provided there is a confirmed, conforming attachment of the required number of other dongles. For example, with reference to system 200, if it is determined that dongle two 212 is not attached, but that dongle one 211 and dongle three 213 are attached in a conforming manner (a simple majority of all of the authorized dongles 211, 212, 213) the system 200 is allowed continued use the licensed feature. Thus, this functionality provides the dual benefits eliminating a single point of failure that could result in an undesirable suspension of use of a licensed feature, and preventing the use of unattached, authorized dongles for unauthorized use of the licensed feature in an unauthorized manner, for example, on an unlicensed system.

As described above, it can be advantageous for the “M of N” determination to mean that greater than 50% of authorized dongles are functioning with greatly reduced risk of blocked access to an otherwise properly authorized feature. For example, if there are three total dongles, but only two continue to function then the display array can continue to function as a whole. However, if only one dongle functions and two are nonfunctioning, then, less than 50% of the total number of authorized dongles would be confirmed as being attached, and the systems 100, 200 would be blocked from using the licensed feature.

Other numbers are contemplated such as at least four functioning dongles out of seven total dongles, at least three functioning dongles out of five total dongles, at least five functioning dongles out of nine total dongles, etc. In such embodiments, as long as greater than 50% of the dongles are confirmed as attached, then the systems 100 200 can continue to function.

In other embodiments of the systems 100 and 200, a confirmed, conforming attachment of one functioning dongle of a system having three authorized dongles can be used to allow indefinite or temporary continuation of the licensed feature.

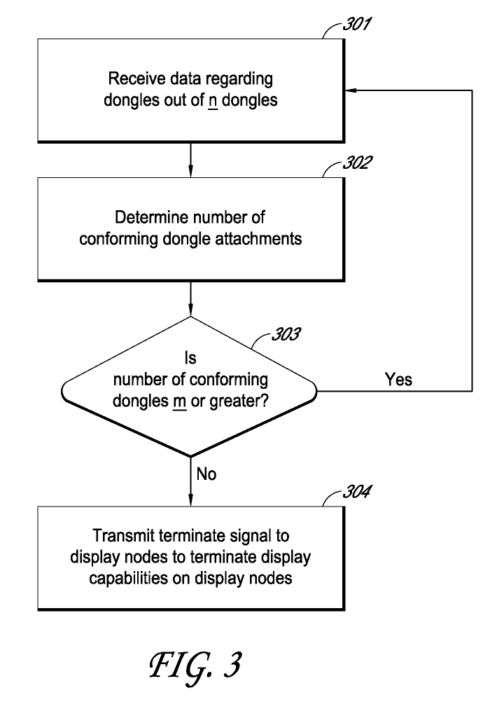

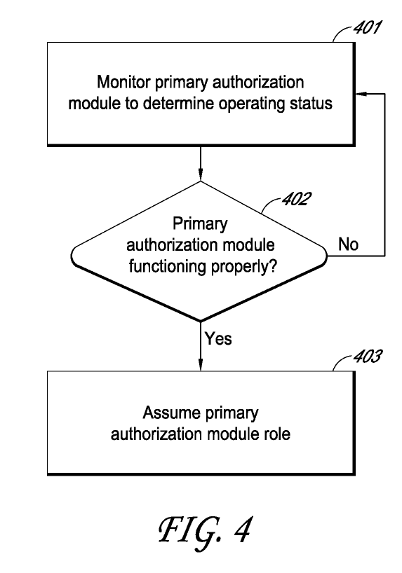

FIGS. 3 and 4 depict processes which can be used with any of the embodiments of systems 100 200 described above, referred to as a “licensed system” in the descriptions of FIGS. 3 and 4 below.

The processes of FIGS. 3 and 4 can be executed via instructions through one or more computer processors on one or more computer systems, such as a licensed system which can include display nodes, control nodes, and other processors.

The process of FIG. 3 can be configured to verify whether or not there are a sufficient numbers of authorized dongles attached to a licensed system. If there are not a sufficient number of authorized dongles attached to the licensed system, then use of the system or licensed features of the system, can be terminated.

The steps of the process illustrated in FIG. 3 are described below as being executed on a control node or display node acting as a control node, however, those steps can be performed with other devices at other locations. Such a process can be executed by licensing authorization module 172 which in some embodiments can be included in control node 102, can be a remote licensing server 231, can be included in any of the above described display nodes, or in other devices of the subject system 100, 200.

In operation block 301, data regarding one or more dongles of a system having a plurality of authorized dongles is received. For example, a licensing authorization module 172 can receive one or more dongle status and dongle identifiers from one or more parts of the associated system. For example, the data received in operation block 301 can correspond dongles all of which are connected to the control node 102, one of the display nodes 100N, or a plurality of different parts of the system 100.

With reference to FIG. 2, in an embodiment of the system 200 which includes only three authorized dongles 211, 212, 213, the control node 102 can receive dongle status updates periodically or asynchronously from display node one 201, display node two 202, and display three 203 for each of these have a dongle attached. For example, the licensing authorization module 172 remote licensing server 231 can be configured to request and receive such status updates or the devices to which the dongles are attached can be configured to automatically send status updates, for example, according to a predetermined schedule. After the operation block 301, the process of FIG. 3 can move to operation block 302.

In operation block 302, it can be determined if the status updates received in operation block 301 are from authorized dongles attached in a conforming manner. For example, the licensing authorization module 172 can be configured to verify each dongle in any of a number of different ways. For example, the received status updates can be compared to a authorized dongle identifiers stored in the license authorization module 172, on the remote licensing server 231, or at another location. The status updates can also be in a form lacking an identifier, for example, in embodiments of dongles including executable code configured to issue output generated by the executable code. In such embodiments, the status updates would be confirmed if the output from the executable code corresponds to output expected by the license authorization module 172. In such embodiments, the control node 102 can be configured to forward the output from the dongles to the remote licensing server 231 for verification.

In some embodiments, the determination of whether a status update from a dongle is conforming can include determining if the status update passed through or is behind a network of a licensed user, based on for example, a comparison of IP addresses of the device sending the status updates with expected IP addresses. After this verification, the remote licensing server 231 can send a message to the license authorization module 172 regarding the verification performed in decision block 303. The message can include data corresponding to the number of dongles confirmed as connected in a conforming manner, also referred to herein as conforming status updates. The message can include, or a further message can also be sent including, for example, an indication whether any of and which of the dongles were not confirmed as being connected in a conforming manner. Such a message, forwarded to a user of the associated system in a comprehensible manner, can help a user identify a failed dongle and avoid a potential future suspension of access to the licensed feature. After the operation block 302, the process can move to decision block 303.

In the decision block 303, it can be determined if the number of conforming status updates detected in operation block 302 is at least a majority of the total number of authorized dongles for the subject system. For example, the control node 102, the license authorization module 172 or the remote licensing server 231 can determine if the received number of conforming updates satisfies a predetermined relationship with a predetermined, known number of authorized dongles associated with the subject system. For example, in some embodiments, it can be determined whether the number of conforming updates is M or greater, where M is a number corresponding to at least a simple majority of the total number of dongles authorized for use on the associated system. If it is determined that M or more than M conforming status updates have been received, then the process can return to operation block 301 and use of the licensed feature can be allowed to continue. For example, the license authorization module 172 can be configured to not take any action or interfere with operation of the associated system or the licensed feature.

If on the other hand, in decision block 303, it is determined that the number of conforming status updates is less than M, the process can move to operation block 304.

In operation block 304, use of the licensed feature can be terminated permanently or temporarily. In some embodiments the termination or suspension of use of the licensed feature can be delayed for a period following the negative determination in decision block 303. For example, the delay can be minutes, hours, days, weeks, months, years, or any amount of time. Such a delay can prevent a suspension of use of the licensed feature where the failure of the receipt of a sufficient number of conforming status updates in operation block 302 is temporary and quickly resolved.

In some embodiments, in operation block 304, a termination command, corresponding to termination of the licensed feature, can be issued. For example, the license authorization module 172 or the remote licensing server 231 can issue a termination command to the control node or any display node in the system configured to prevent use of the licensed feature.

In the alternative, in some embodiments, components of a system can be configured to continuation operation only if an authorization message is received, for example, according to a predetermined schedule. Thus, in such embodiments, no terminate signal need be sent. For example, a display node can require receiving updates such as content updates or code updates to the display nodes in order to continue functioning or in order for the dongle to continue functioning. Thus, if such information is not sent then each display node can in turn be programmed through computer executable instructions to cease functioning. In any case, a signal to terminate or lack thereof to continue can be used in block 304 to inform the display nodes and the display array to cease functioning.

Thus, the process described in FIG. 3 can allow for a single or multiple dongles to be nonfunctioning and better prevent unintended loss of use of a licensed feature.

FIG. 4 illustrates another process that can be used for operation of a distributed hardware security system. In addition to the options disclosed above, the process shown in FIG. 4 can also be executed by a backup license authorization module 182 that can be located in any of the display nodes, another device 180, or another control node connected with the system, so as to perform the functions of the license authorization module 172, should it cease to function or have an error. For example, the control node 102 can be a general purpose computer, which could fail, can need to be disconnected for maintenance, require one or more prolonged re-boots, or a variety of other causes of temporary or permanent non-operation. If the only license authorization module 172 were running on a control node 102 ceases operation, use of licensed features would be suspended unintentionally.

In the process of FIG. 4, in block 401, operation of the license authorization module 172, which can be considered to be a “primary authorization module,” can be monitored. For example, a backup license authorization module, which can be located on a different computing device 180 than that on which the license authorization module 172 is disposed, can monitor the primary authorization module 172 to determine whether or not the primary license authorization module 172 is functioning properly. For example, in some embodiments, the licensed authorization module 172 can send a signal to the backup authorization module 182 periodically, the receipt of which can be considered as an indication that the primary license authorization module 172 is functioning correctly. Optionally, the signal can include data corresponding to an affirmative confirmation that the primary license authorization module 172 is functioning correctly, for example, a signal including a predetermined data string or message, or real time generated data indicating functionality of the primary license authorization module 172.

In some embodiments, the backup authorization module 182 can be configured to receive communications regarding dongle confirmation performed in operation block 302 of FIG. 3. For example, where the backup license authorization module 182 is located in a display node, such as display node three 203, messages coming to and/or from that display node 203 can be received by the backup license authorization module 182. The backup license authorization module 182 can be configured to determine if such communications are consistent with proper functioning of the license authorization module 172.

For example, timing of the communications from the license authorization module 172 can be compared to a predetermined timing of communications consistent with proper functioning of the primary license authorization module 172. Absent expected and/or frequent communication from the primary licensed authorization module 172, the backup authorization module 182 can be configured to determine that the primary authorization module is not functioning properly.

If it is determined, in decision block 402, that the primary authorization module is functioning properly, the process can return to operation block 401 and repeat.

On the other hand, if it is determined that the primary authorization module is not functioning properly, then the process can proceed to operation block 403.

In the operation block 403, the functionality of the primary authorization module 172 can be provided by a different authorization module that can be disposed on a different part of the system, such as a different physical device than the device on which the primary authorization module 172 is disposed. For example, the backup authorization module 182 can be disposed on any device 180 in the system that has the hardware sufficient for performing the functionality of the primary authorization module 172. For example, one, a plurality, or all of the display nodes in either system 100, 200 can include a backup authorization module 182. Additionally, any other capable device connected to the system 100, 200, for example, original image data sources 164, devices used as an alternative control node, or other devices 180 can include a backup authorization module 182, which include sufficient hardware for providing the functionality of the backup authorization module 182, which can be a general purpose computer. In embodiments where the backup authorization module 182 is in the form of software that can run on a general purpose computer, the backup authorization module 182 can be installed along with or integrated into the software stored on all of the display nodes for providing the functionality of the display nodes, or the software used to provide the functionality of a control node of the systems 100, 200. This can simplify the installation and normalize the availability of a backup authorization module 182 on a system.

In some embodiments, optionally, the backup authorization module 182 can transmit messages, data, or instructions to the dongles or the devices attached to all of the dongles, to report dongle status to the backup authorization module 182, which can be on a device 180, 280 having a different IP address than the device (control node 102) on which the primary license authorization module 172 is disposed, disposed in a different physical location, associated with a different local area network, or other physical or virtual locations.

As such, the backup authorization module 182 can provide the license verification functionality of the primary authorization module 172, and thereby support continued use of the licensed feature, with little or no loss of availability. Optionally, the substitution of the primary authorization module 172 by the backup authorization module 182, can be reported to and/or verified by a licensing server such as licensing server 231 or can be independently verified by the backup license authorization module itself, independently. Such a report can be transmitted over the local area network to each display node directly to each display node or as a broadcast. Such communication can also comprises an authentication code, such as a MAC, or any other HASH or encryption (shared secret, or private/public key) so that the display nodes only switchover to a backup authorization module 182 in a trusted manner.

Thus the backup authorization module 182 can then properly perform the functions necessary for determining whether or not M of N dongles are functioning within the system, either continue allowing use of the licensed feature, or terminate use of the licensed feature on the system. Advantageously, using this optional method, the systems 100, 200 can better avoid potential loss of access to properly licensed features which could be caused by malfunctioning equipment that is not necessary for operation of the associated system.

Optionally, the process of FIG. 4 can include an operation of assigning the role of the primary authorization module 172, for example, optionally, selecting which of a plurality of available backup authorization modules. The backup authorization module process or role can be assigned to a specific display node (or second control node) either manually, or automatically. For example, the process of FIG. 4 can include the optional operation of receiving data indicative of process utilization of one or more of the devices in the system 100, 200 on which one or more backup authorization modules 182 are disposed. For example, process utilization can be measured using standard techniques known in the art over a period of time.

Thus, for example, the process of FIG. 4 can include a backup selection operation which can determine which of a plurality of available backup authorization modules 182 shall be assigned the role of the primary authorization module, based on the received data. For example, all or part of the received data indicative of process utilization can be compared based on any comparison technique or algorithm, including a direct scalar comparison. Optionally, the data received can be compared with predetermined values. As such, the process of FIG. 4 can also optionally include the operation of selectively assigning the primary authorization module role to a device of the system 100, 200 whose process utilization is, for example, the lowest (as measured using standard techniques known in the art over a period of time) out of all of the display nodes in the system.

Alternatively or in combination, the operation of selectively assigning the primary authorization module role can include automatically assigning, based on a determination of memory usage of the devices including the plurality of available backup authorization modules 182 (e.g. node with the most free memory can be assigned the role). In such embodiments, optionally, some or all of the devices in the systems 100, 200 can be configured to provide relevant data in response to a request for data relevant to such process or memory utilization determinations. Along those lines, the device performing the backup selection operation can issue requests for data relevant to utilization determinations (e.g., process utilization as a percentage of total processing capacity and/or free memory) to all of the devices in the system on which the available backup authorization modules 182 are reside.

Further, optionally, one of a plurality of available backup authorization modules 182 can be arbitrarily assigned the role of the backup selection operation and thus perform all or part of backup selection operation, i.e. which of the plurality of available backup authorization modules 182 shall be assigned the role of the primary authorization module 172. Such an assignment can optionally be in accordance with a predetermined defined order of which of the plurality of backup authorization modules should be assigned the backup determination role. This can improve the likelihood that that such an assigned device has adequate computing resources available for providing the backup authorization module with less interference or slowing of other functionalities provided by the assigned device.

The types of connections, attachments, or couplings disclosed above, any coupling, attachment, or connection discussed herein can be provided by wired and/or wireless systems forming all or part of a local area network, wireless local area network, wide area network, metropolitan area network, storage area network, system area network, server area network, small area network, campus area network, controller area network, cluster area network, personal area network, desk area network or any other type of network.

Any of the computers, laptops, server, including the proxy server, control nodes, workstation, display nodes, or other devices herein can be in the form of any type of computer system. A computer system can include a bus or other communication mechanism for communicating information, and a processor coupled with bus for processing information. Computer systems can also include a main memory, such as a random access memory (RAM), flash memory, or other dynamic storage device, coupled to bus for storing information and instructions to be executed by processor. Main memory also can be used for storing temporary variables or other intermediate information during execution of instructions to be executed by processor. Computer system can further include a read only memory (ROM) or other static storage device coupled to a bus for storing static information and instructions for processor. A storage device, such as a magnetic disk, flash memory or optical disk, can be provided and coupled to bus for storing information and instructions.

Some of the embodiments herein are related to the use of computer system for the techniques and functions in a networked system. In some embodiments, such techniques and functions can be provided by a computer system in response to processor executing one or more sequences of one or more instructions contained in main memory. Such instructions can be read into main memory from another computer-readable storage medium, such as storage device. Execution of the sequences of instructions contained in main memory can cause a processor to perform the process steps described herein. In alternative embodiments, hard-wired circuitry can be used in place of or in combination with software instructions to implement embodiments. Thus, the embodiments disclosed herein are not limited to any specific combination of hardware circuitry and software.

The term “computer-readable storage medium” as used herein, in addition to having its ordinary meaning, refers to any medium that participates in providing instructions to a processor for execution. Such a medium can take many forms, including but not limited to, non-volatile media and volatile media. Non-volatile media includes, for example, optical or magnetic disks, such as a storage device. Volatile media includes dynamic memory, such as main memory. Transmission media includes coaxial cables, copper wire and fiber optics, including the wires that comprise a bus.

Common forms of computer-readable media include, for example, a floppy disk, a flexible disk, hard disk, magnetic tape, or any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge.

Computer systems can send messages and receive data, including program code, through the networks or other couplings. The received code can be executed by a processor as it is received, and/or stored in storage device, or other non-volatile storage for later execution.

In general, the word “module,” as used herein, refers to logic embodied in hardware or firmware, or to a collection of software instructions, possibly having entry and exit points, written in a programming language, such as, for example, Java, Lua, Objective-C, C or C++. A software module can be compiled and linked into an executable program, installed in a dynamic link library, or can be written in an interpreted programming language such as, for example, BASIC, Perl, or Python. It will be appreciated that software modules can be callable from other modules or from themselves, and/or can be invoked in response to detected events or interrupts. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The modules described herein are described as implemented as software modules, but can be implemented in hardware or firmware, or combinations of software, hardware and/or firmware. Consistent with this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure. Generally, the modules described herein refer to logical modules that can be combined with other modules or divided into sub-modules despite their physical organization or storage.

Each of the processes, components, and algorithms described above can be embodied in, and fully automated by, modules executed by one or more computers or computer processors. The modules can be stored on any type of computer-readable medium or computer storage device. The processes and algorithms can also be implemented partially or wholly in application-specific circuitry. The results of the disclosed processes and process steps can be stored, persistently or otherwise, in any type of computer storage. In addition, the modules can comprise, but are not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, variables, or the like.

Conditional language used herein, such as, among others, “can,” “could,” “might,” “may,” “e.g.,” and the like, unless specifically stated otherwise, or otherwise understood within the context as used, is generally intended to convey that one or more embodiments can optionally include the subject features, elements and/or states. Thus, such conditional language is not intended to imply that features, elements and/or states are in any way required for one or more embodiments or that one or more embodiments necessarily include logic for determining whether, with or without author input or prompting, such features, elements and/or states are included or are to be performed in any particular embodiment or logic for executing or providing these features, elements and/or states.

Although the foregoing description includes certain embodiments, other embodiments will be apparent to those of ordinary skill in the art from the disclosure herein. Moreover, the described embodiments have been presented by way of example only, and are not intended to limit the scope of the inventions. Indeed, the novel methods and systems described herein can be embodied in a variety of other forms without departing from the spirit thereof. Accordingly, other combinations, omissions, substitutions and modifications will be apparent to the skilled artisan in view of the disclosure herein. Thus, the present inventions are not intended to be limited by the disclosed embodiments or the claims contained herein or added to this or any other document; other claims directed to one of more of the inventions disclosed herein may be developed in the future.

What is claimed is:

1. A computerized display system with a distributed hardware security system, comprising:
a plurality of displays, wherein each display of the plurality of displays is deployed in close proximity to another display in the plurality of displays;
a plurality of display nodes comprising computer hardware, each display node configured to display content on at least one locally connected display of the plurality of displays, each display node connected via local area network to an authorization node;
one or more workstations connected to the plurality of display nodes;
wherein n of any of the plurality of display nodes and one or more workstations are each electronically connected to, and associated with, a separate, unique license dongle of m dongles,
wherein each individual display node and workstations connected to any of the m dongles are configured to:
periodically detect a status of the connected unique license dongle;
periodically transmit the status of the unique license dongle to the authorization node based on the detected status; and
the authorization node being configured to, based on received statuses of dongles from the n display nodes, detect whether m of n license dongles are valid, wherein m is greater than 1, and in response to detecting less than m license dongles as valid, terminate at least one display capability of the computerized display system.

2. The computerized display system according to claim 1, wherein m is greater than half of n.

3. The computerized display system according to claim 2, wherein m is equal to 2 and n is equal to 3.

4. The computerized display system according to claim 2, wherein m is equal to 3 and n is equal to 5.

5. The computerized display system according to claim 1, wherein the authorization node is included in the at least one workstation, the workstation configured to be a control node of the display system, the control node further configured to assign display information to each display node of the plurality of display nodes.

6. The computerized display system according to claim 1, further comprising a second redundant authorization node distinct from the authorization node and configured to:
based on received statuses of dongles from the n display nodes, detect whether m of n license dongles are valid, and
in response to detecting less than m license dongles as valid, terminate at least one display capability of the computerized display system.

7. The computerized display system according to claim 6, wherein the second redundant authorization node is further configured to only terminate display capabilities of the computerized display system if, additionally, the authorization node is unresponsive.

8. The computerized display system according to claim 6, wherein the second redundant authorization node is an assignable role among the plurality of display nodes.

9. The computerized display system according to claim 1, wherein the authorization node is further configured to:
verify, via the Internet, with a license server, the authorization status of each unique license dongle.

10. A computerized method of authorizing an arrayed display system including n discrete display devices disposed adjacent one another, the method comprising:
periodically receiving, over a local area network, an active dongle status indication from one or more of the n discrete display devices, wherein each of the n discrete display devices are electronically connected to an external license dongle and n is greater than 1;
verifying an authorized license for each active dongle status indication received;
determining whether less than m dongles are authorized based on verification of each authorized license, wherein m is greater than 1; and
in response to determining that less than m dongles are authorized, terminating at least one display capability of at least a portion of the arrayed display system.

11. The computerized method according to claim 10, wherein m is greater than half of n.

12. The computerized method according to claim 10, wherein m is equal to 2 and n is equal to 3.

13. The computerized method according to claim 10, wherein m is equal to 3 and n is equal to 5.

14. The computerized method according to claim 12, further comprising assigning display information to each discrete display device.

15. The computerized method according to claim 12, wherein verifying the authorized license for each active dongle status indication received comprises, for each active dongle status indication:
transmitting, over the Internet, a dongle identifier associated with the dongle status indication; and
in response to the transmitting, receiving, over the Internet, an indication of authorization of the dongle identifier.

16. A computer program stored in a computer readable media and configured to cause a computer to control the display of media objects on an arrayed display system including a plurality of display devices disposed adjacent one another, the program comprising:
a display media control module configured to determine the media to display on at least one of the plurality of display devices; and
a license authorization module configured to determine whether m dongles are authorized out of n total, unique dongles distributed among, and electronically connected to, individual display devices of the plurality of display devices,
the license authorization module further configured to terminate the display capabilities of one or more of the plurality of display devices in response to determining that less than m authorized dongles are functioning throughout the plurality of display devices.

17. The computer program according to claim 16, wherein m is greater than half of n.

18. The computer program according to claim 16, wherein m is equal to 2 and n is equal to 3.

19. The computer program according to claim 16, wherein m is equal to 3 and n is equal to 5.

20. The computer program according to claim 16, wherein the license authorization module is further configured to transmit a keep-alive indication to a backup license authorization module.

21. A computer program stored in a computer readable media and configured to provide functionality amongst a plurality of processor devices and distributed-hardware security, the program comprising:
a license authorization module configured to recognize n licensed security devices connected to a plurality of different processor devices connected by a network;
the license authorization module being configured to determine whether at least m licensed security devices are attached to m of the different processor devices connected to the network;
the license authorization module further configured to terminate at least one capability of one or more of the plurality of processor devices in response to determining that less than m authorized dongles are functioning throughout the plurality of display devices, wherein m is less than n.

22. The computer program according to claim 21, wherein m is greater than one-half of n.
